(19) United States
(12) Patent Application Publication
(10) Pub. No.: US 2025/0325136 A1
(43) Pub. Date: Oct. 23, 2025

(54) POD CONTAINER OPENING SYSTEM AND METHOD FOR USE IN A BEVERAGE BREWING APPARATUS

(71) Applicant: Smart Coffee Technology, Inc., San Carlos, CA (US)

(72) Inventor: Timothy Joel Hussey, Redwood City, CA (US)

(21) Appl. No.: 18/641,162

(22) Filed: Apr. 19, 2024

(51) Int. Cl. A47J 31/40; A47J 31/44

(52) U.S. Cl. CPC A47J 31/407; A47J 31/4492

(57) ABSTRACT

Systems and methods for extracting whole beverage ingredients from a beverage pod are disclosed herein. A system for extracting whole beverage ingredients from a beverage pod comprises an electromechanical opening module and a pod clamp assembly. The electromechanical opening module is configured to rotate the pod from a closed state, where the whole beverage ingredients are contained within the pod, to an open state where the whole beverage ingredients are released from the pod. The pod clamp assembly operates in concert with the electromechanical opening module and is configured to retain an exposed portion of the pod lid in a fixed position while the electromechanical opening module rotates the pod from the closed state to the open state to peel back the pod lid to release the pod ingredients.

### CROSS REFERENCE TO RELATED APPLICATIONS

This application is related to U.S. application Ser. No. 18/081,645 filed Dec. 14, 2022, which is a continuation of U.S. application Ser. No. 16/747,338 filed Jan. 20, 2020, now U.S. Pat. No. 11,534,019, which is a continuation of U.S. application Ser. No. 15/970,839 filed May 3, 2018, now U.S. Pat. No. 10,537,202, which claims the benefit of U.S. Provisional Application No. 62/500,734 filed May 3, 2017. This application is also related to U.S. Non-Provisional patent application Ser. No. 18/635,684, filed Apr. 15, 2024, titled “Beverage Pod with a Foldable Segmented Lid that Contains Whole Brewing Elements.” The contents of all of the aforementioned disclosures are hereby incorporated in reference in their entireties for all purposes.

### FIELD OF THE PRESENT TECHNOLOGY

The present disclosure pertains to a pod container opening system for a brewing device. In particular, it pertains to a pod container opening system that quickly and easily removes a portion of a pod lid cover to release whole beverage ingredients contained within a pod to perform a brewing operation.

### BACKGROUND

The present disclosure relates to a beverage brewing apparatus for making beverages such as coffee or tea. The apparatus operates on beverage pods that contain whole beans or leaves. There are many types of counter-top beverage machines that can brew a beverage. In general, there are two styles of beverage machines: soluble container machines and hopper machines. Both systems have various advantages and disadvantages. Soluble container beverage machines are economical and have a small counter-top footprint. Further, soluble container machines allow a wide range of single-service beverages to be produced by the machine. A user inserts a container including a soluble substance into the machine and the machine brews a beverage using the soluble substance. However, because the soluble substances are pre-packaged, these machines do not allow for “freshly ground” beverages to be brewed. Hopper machines have a larger footprint and are more expensive. However, hopper machines allow a user to produce a beverage using a freshly ground substance. Hopper machines include a hopper that can be filled with a substance that can be freshly ground and brewed into a beverage. However, due to the nature of the brewing process in hopper machines, they only allow for a user to brew a beverage using whatever substance is in the hopper. There are usually only a few different beverage options in a hopper machine.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A pod container opening system and method which is particularly useful in coffee brewers and other brewing devices is disclosed. The design incorporates an electromechanical opening module including a pod holder shaft rotatably disposed about a tangent point above a pod holder configured to initiate rotation of an inserted beverage pod from a closed state to an open state. A pod lid clamp assembly is disposed beneath the electromechanical opening module including a spring mechanism that is slidably disposed within an interior cavity of the pod lid clamp assembly configured to retain a portion of the pod lid in a stationary state while the pod is rotated from the closed state to the open state by the electromechanical opening module.

The design permits quick and easy opening of a beverage pod to release the whole beverage ingredients for a brewing operation. The described pod container opening system is further advantageous in that it allows for easy disposal of the pod after it has been opened.

According to some embodiments, the present disclosure relates to a pod container opening system comprising a electromechanical opening module; and a pod lid clamp assembly; the electromechanical opening module comprising: a pod holder arranged to receive pods, the pods being comprised of a pod lid and pod container including whole beverage ingredients; a pod door configured to enclose the loaded pod in the pod holder during operation; a chute configured to interface the pod holder to the pod door; a pod opener arm assembly configured to initiate a rotation of the pod holder containing the loaded pod from a closed state to an open state to release whole beverage ingredients contained within the pod; and the pod lid clamp assembly comprising: a spring mechanism coupled to a knurled exterior surface, the pod lid clamp assembly configured to retain an exposed portion of the pod lid in a fixed position abutting the pod door while the pod opener arm assembly rotates the pod holder and loaded pod from the closed state to the open state to allow the pod lid to be become substantially separated from the pod container to release the whole beverage ingredients.

According to some embodiments, an example method can include, opening a pod door; inserting the pod in the pod holder; closing the pod door; determining that the pod door is closed; scanning the pod in the pod holder for a pod identification; starting a machine cycle to extract the whole beverage ingredients from the pod; the processor determines that there is a pod in the pod holder; the processor locks the pod door upon successfully determining that there is a pod in the pod holder; the pod container opening system stripping the label

According to some embodiments, the step of starting a machine cycle to extract the whole beverage ingredients from the pod may comprise: actuating an opener arm of an electromechanical opening module to rotate the pod from the initial closed state to the final open state; retaining a portion of a pod lid in a stationary position while the opener arm rotates the pod from the initial closed state to the final open state to peel away a portion of the pod lid from the pod container to release the whole beverage ingredients from the pod container.

According to one aspect of the present disclosure, a non-transitory computer-readable storage medium having embodied thereon instructions, which when executed by a processor, perform steps of the methods substantially as described herein.

The pod container opening system may further comprise one or more processors and a memory for storing instructions, the instructions being executed by the processor to carry out the methods described herein.

Other example embodiments of the disclosure and aspects will become apparent from the following description taken in conjunction with the following drawings.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a perspective view of the beverage machine including a pod container opening system, according to one example embodiment.

FIGS. 2-3 illustrate a beverage pod in the closed and open state, according to one example embodiment.

FIGS. 4-5 illustrates a beverage pod in the open state highlighting a portion of the pod lid being peeled away from the pod container, according to one example embodiment.

FIGS. 6A-6B illustrate front and back perspective views of an electromechanical opening module as one component of a pod container opening system, according to one example embodiment.

FIGS. 7A and 7B illustrate a pod lid clamp assembly as a second component of a pod container opening system in the compressive state and non-compressive state, according to one example embodiment.

FIGS. 8-9 illustrate front and rear views of a pod door, according to one example embodiment.

FIG. 10 illustrates a front perspective view of certain elements of the electromechanical opening module illustrating a tangent point of rotation of the pod holder, according to one example embodiment.

FIGS. 11A-11D illustrate a process for peeling away a pod lid by the electromechanical opening module during rotation of the pod lid from the closed state to the open state, according to one example embodiment.

FIG. 12 is a flowchart of an example method of the present disclosure.

FIG. 13 is a simplified block diagram of system control features of the present disclosure, according to one example embodiment.

FIG. 14 is a simplified block diagram of an exemplary computing system that is used to implement embodiments according to the present technology.

### DETAILED DESCRIPTION OF EMBODIMENTS

Detailed embodiments of the present invention are disclosed herein; however, it is to be understood that the disclosed embodiments are merely illustrative of the present disclosure that may be embodied in various forms. In addition, each of the examples given in connection with the various embodiments of the present disclosure are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

It will be understood that the exemplary embodiments are described with particular reference to the field of coffee preparation. However, the present disclosure is also applicable to the preparation of a wide variety of beverages. For the purpose of the present description, a “beverage” is meant to include any human-consumable liquid substance, such as tea, coffee, hot or cold chocolate, milk, soup, etc.

Systems and methods are described herein for extracting whole beverage ingredients from a pod in a beverage brewing apparatus. The pod contains one or more whole beverage ingredients to produce a single serving beverage. A container opening system operates on the pod to remove the whole beverage ingredients. Briefly, the pod is mechanically operated on by the container opening system to transform the pod from an initial closed state to a final open state. In the closed state the brewing elements are contained within the pod and in the open state the beverage elements are released from the pod to allow a brewing operation to be carried out by the beverage brewing apparatus.

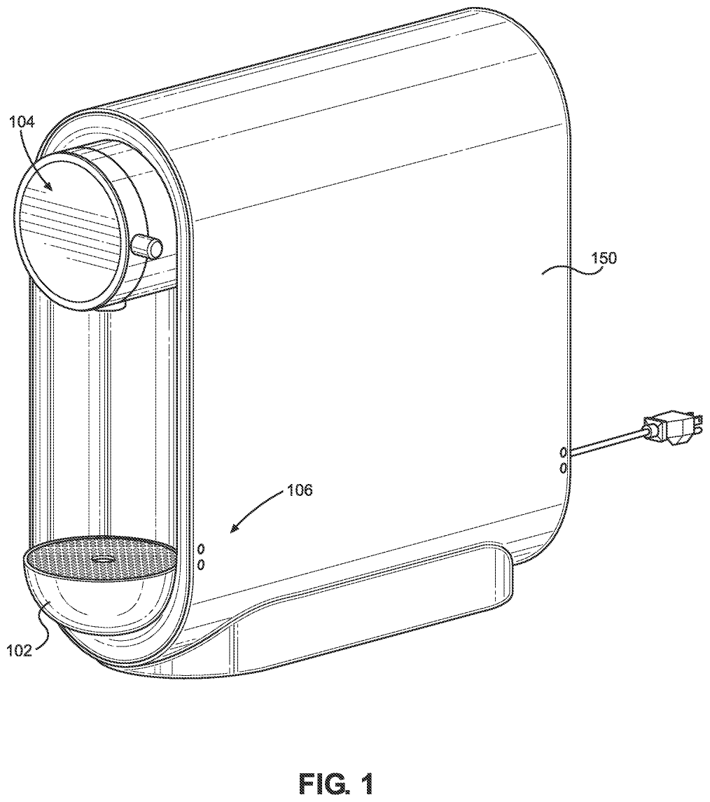

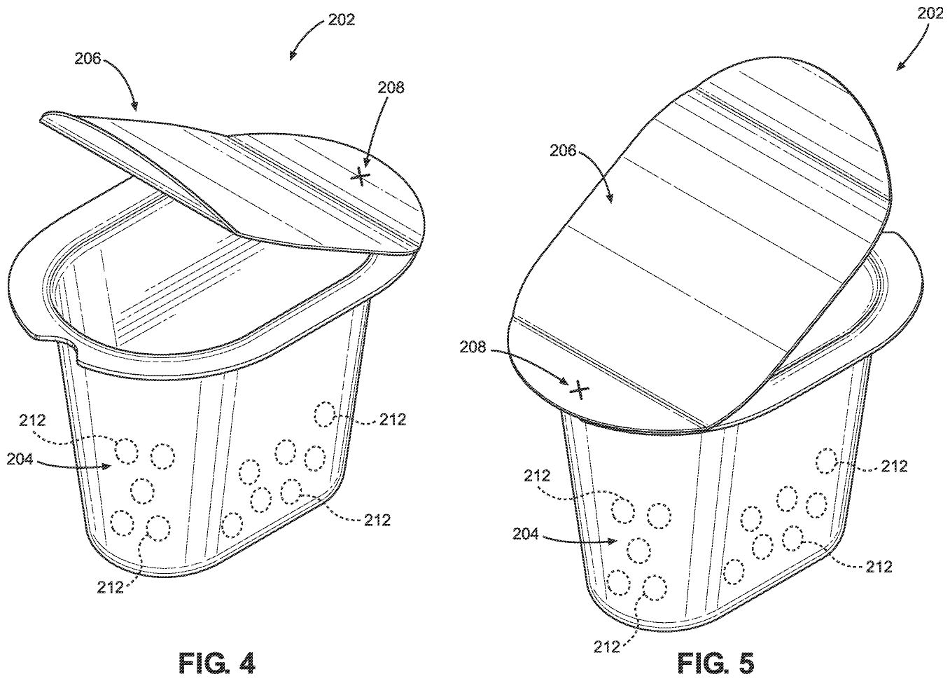

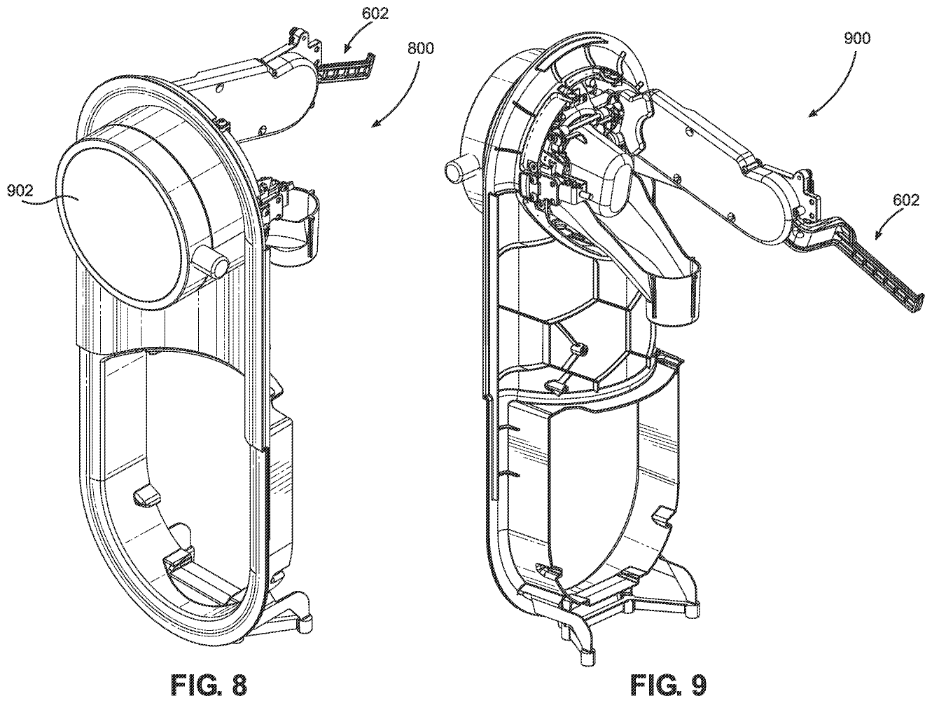

FIGS. 1-13 illustrate various aspects of a container opening system of the present disclosure for use in a beverage brewing apparatus 100.

FIG. 1 illustrates a perspective view of a beverage brewing apparatus 100 according to an embodiment of the present disclosure. Of note, brewing apparatus 100 may include base 102, upon which a cup may be placed to receive the brewed beverage. The brewing apparatus 100 may further include pod door 104 enclosing a pod input area, disposed above base 102, for inserting a beverage pod 202. Various controls 106 may be provided to operate the brewing apparatus 100, such as a start button for starting a brewing process. During the brewing process the brewing apparatus 100 is configured to dispense a beverage into a cup that the user can insert onto the base 102. Housing 150 houses internal components of the brewing apparatus 100 including a container opening system of the present disclosure to be described as follows.

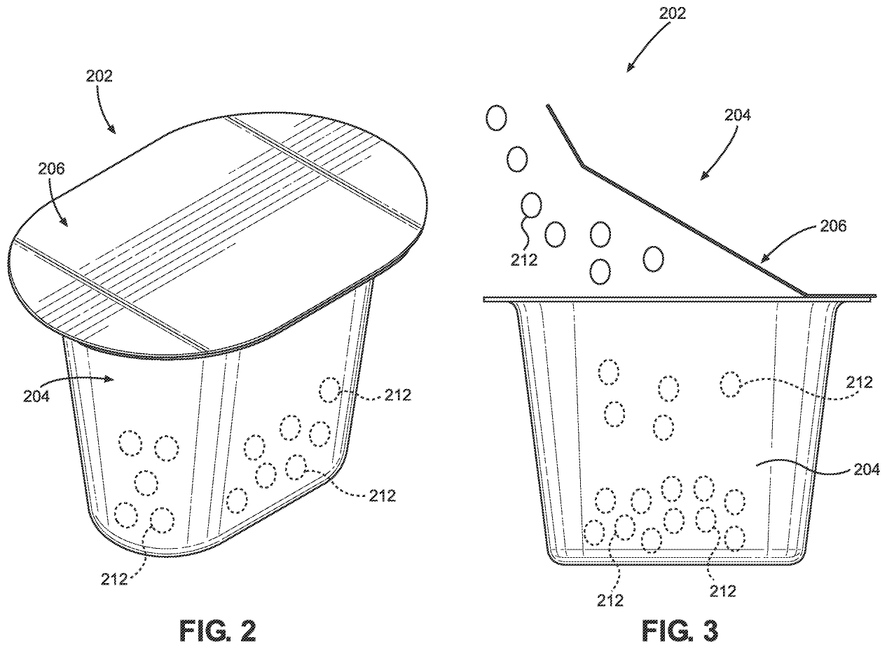

Suitable pods for use in the beverage brewing apparatus 100 of FIG. 1 are illustrated in FIGS. 2-5. A typical pod 202 has a generally cup-shaped container 204, for containing a beverage ingredient 212 (e.g., coffee beans). The pod container 204 may be covered by a heat-sealed pod lid 206.

A pod container opening system 600, 700 of the present disclosure is configured to transform pods 202 from a closed state (e.g., see FIG. 2) to an open state (e.g., see FIGS. 3-5). The closed state is defined herein as a state in which whole beverage ingredients 212 are fully contained or sealed within the pod container 204. The open state is defined herein as a state in which whole beverage ingredients 212 are substantially fully dispensed from the pod container 204. Of note, in the closed state the pod lid 206 is sealed to the pod container 204 and in the open state, the pod lid 206 is substantially peeled away from the pod container 204 thereby allowing the whole beverage ingredients 212 to be substantially fully dispensed from the pod container 204.

As will be described herein, the pod container opening system 600, 700 provides a novel system and associated method for peeling back the pod lid 206 from the pod container 204 to efficiently dispense whole beverage ingredients 212 from the pod container 204 as the pod is transformed from the closed state to the open state.

### Pod Container Opening System

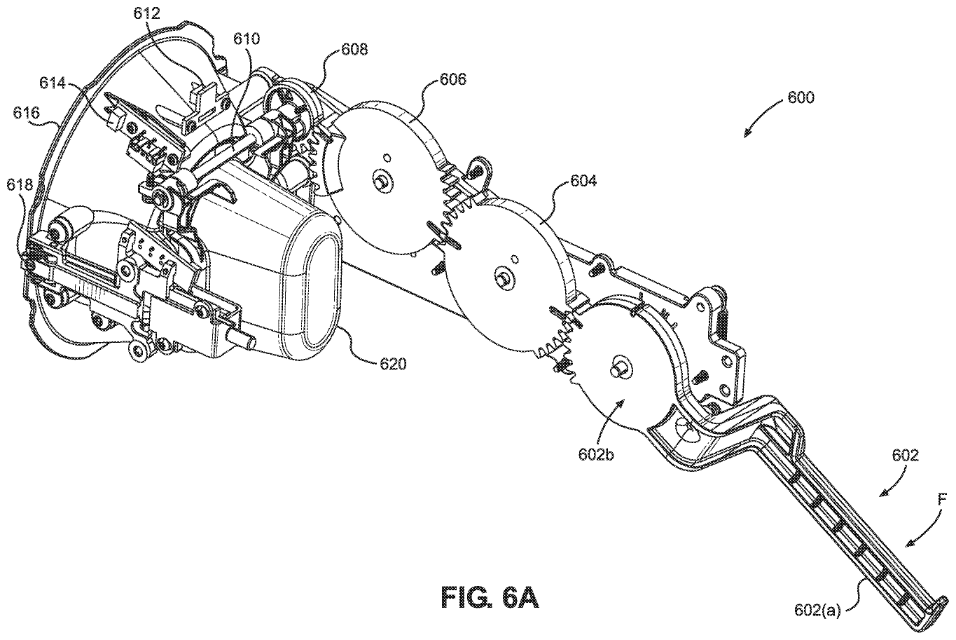

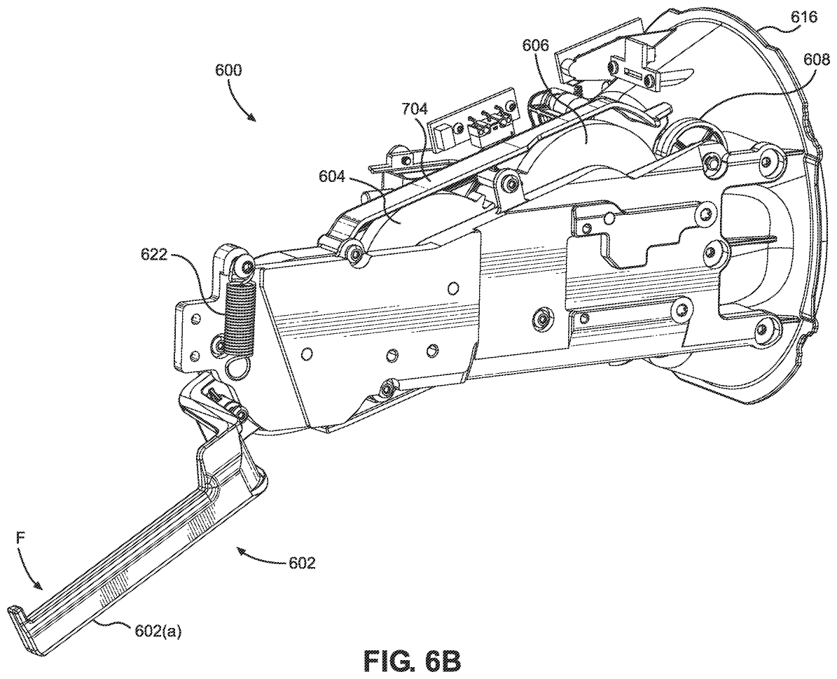

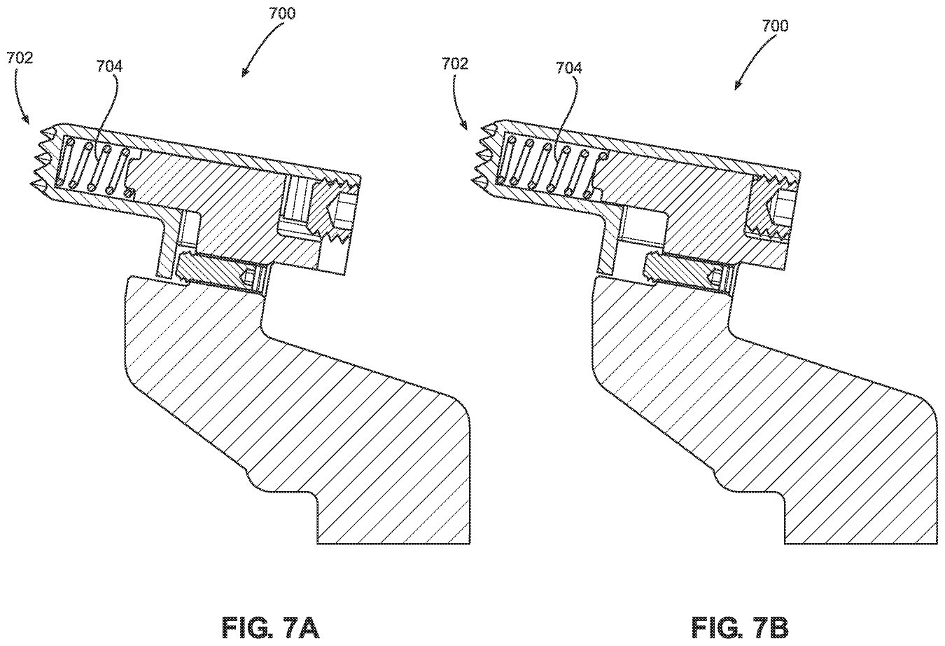

FIGS. 6A-6B and 7A-7B illustrate a pod container opening system 600, 700, according to an embodiment. In an embodiment, the pod container opening system 600, 700, is comprised of two parts, a first part comprised of an electromechanical opening module 600, as shown in FIGS. 6A and 6B, and a second part comprised of a pod lid clamp assembly 700, as shown in FIGS. 7A and 7B. As will be described further below, the first and second parts of the pod container opening system 600, 700, operate jointly to rotate the pod 202 from the closed to the open state to eventually release beverage elements from the pod.

The general operation of pod container opening begins with the insertion of a pod 202 into a pod receptacle 620 of the pod container opening system 600, 700. Once inserted, the pod container opening system rotates the pod 202 inserted into the receptacle 620 from a closed state to an open state to dispense whole beverage ingredients 212 from the pod container 204 as part of the brewing cycle.

In an embodiment, the pod container opening system 600, 700, is comprised of two parts or components, a first component comprised of an electromechanical opening module 600, as shown in FIGS. 6A and 6B, and a second component comprised of a pod lid clamp assembly 700, as shown in FIGS. 7A and 7B. It is to be understood that the first and second components 600, 700, operate jointly to rotate the pod 202 from the closed to the open state as will be described.

### Pod Opening System—Electromechanical Opening Module

FIGS. 6A and 6B illustrate front and rear views of the first part or component of the two-part pod container opening system, referred to herein as the electromechanical opening module. This module is configured to rotate a pod 202 inserted in a pod receptacle 620 of the brewing apparatus 100 from the closed state to the open state. As shown in FIGS. 6A and 6B, the electromechanical opening module 600 includes a number of structural and functional components including a pod opener arm assembly 602, a first opener idler gear 604, a second opener idler gear 606, an opener pinned gear 608, a pod holder shaft 610, a reed sensor breakout 612, a limit switch 614, a chute 616, a door lock assembly 618 and a pod holder 620.

In an embodiment, the pod opener arm assembly 602 is further comprised of an elongate mechanical arm 602a coupled to rotational gear 602b at a first distal end that is operably meshed with first rotational gear 604.

At an initial stage of the brewing process, the pod opener arm assembly 602 may receive a downward mechanical force “F” supplied from an internal motor (not shown) triggered by the initiation of a brewing cycle, causing rotational gear 602b, coupled at the first distal end of the assembly to rotate and rotate in turn, first opener idler gear 604, second rotational gear 606 and opener pinned gear 608 causing pod holder 620 to rotate upwards towards the open state. The pod holder 620 is shown hinged on pod holder shaft 610 under control of pinned gear 608 to cause upward rotation of the pod holder 620. When the mechanical force “F” is no longer applied by the internal motor, the opener arm assembly 602 is otherwise maintained in the non-actionable position shown in FIG. 6A by return spring mechanism 622 shown in FIG. 6B.

### Pod Opening System—Pod Clamp Assembly

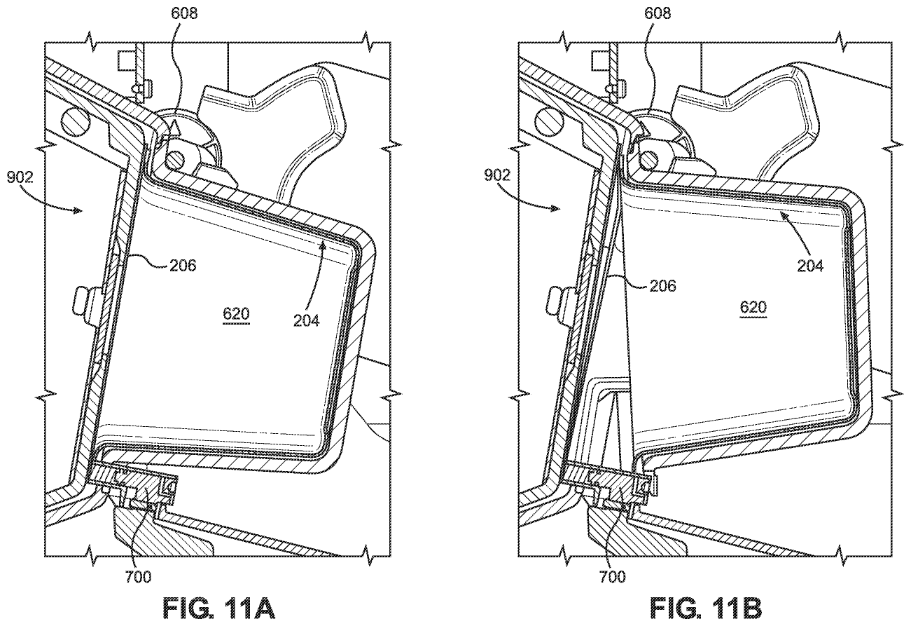

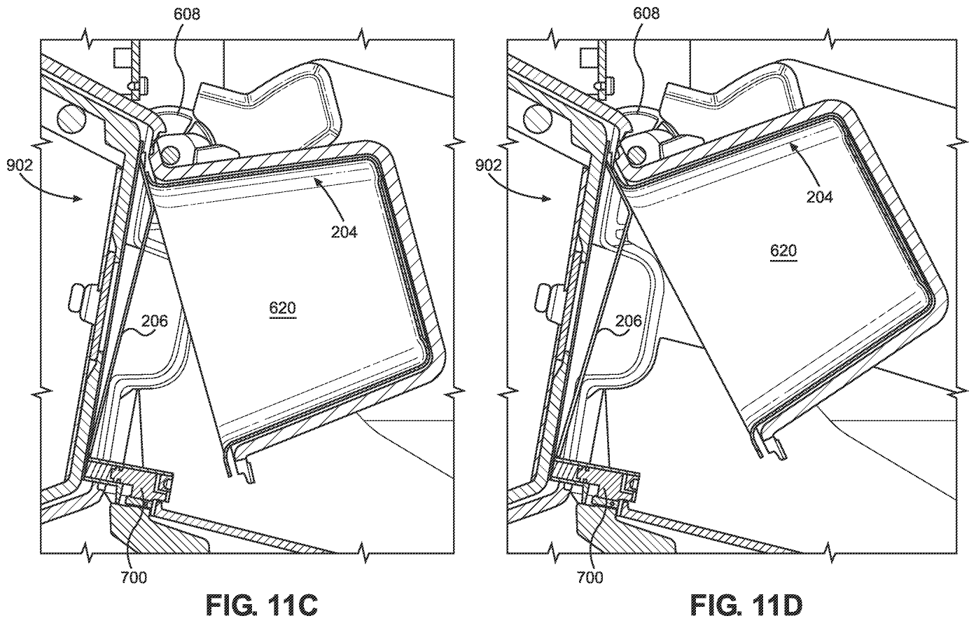

FIGS. 7A-7B illustrate 7B illustrate the pod lid clamp assembly 700 as a second component of a pod container opening system. FIG. 7A illustrates the pod lid clamp assembly in the compressive state and FIG. 7B illustrates the pod lid clamp assembly in the non-compressive state. The pod clamp assembly 700 is arranged beneath the electromechanical opening module 600, as best shown in FIGS. 11A-11D.

In operation, the pod clamp assembly 700 operates in coordination with the electromechanical opening module 600 to peel away a portion of the pod lid 206 by applying a constant compressive mechanical force against an exposed portion 208 of the pod lid 206, as backstopped by the pod door 902 as shown in FIG. 9. The exposed portion 208 of the pod lid 206 is best shown in FIG. 5. Pod door 902 serves the dual function of encasing the pod in the pod holder 620 during operation and acting as a backstop to the compressive mechanical force applied to the exposed portion 208 of the pod lid 206 by restricting movement of the exposed portion of the pod lid 206 from the backside in a manner described below with regard to FIGS. 11A-11.

Thus, the combination of pod rotation, achieved by the electromechanical opening module 600 coupled with restricted movement of the pod lid 206 by the pod lid clamp assembly 700, causes the pod lid 206 to be largely peeled away from the pod container 204 during rotation of the pod 202 to release the whole beverage ingredients 212.

As shown in FIGS. 7A-7B, the pod clamp assembly 700 includes a knurled outer surface 702. The knurled outer surface 702 serves to grab the pod lid 206 and retain it in a stationary state during rotation of the pod holder 620. In operation, the knurled outer surface 702 of the pod clamp assembly is projected towards the exposed portion 208 of the pod lid 206 via a mechanical spring action supplied by spring element 704. FIG. 7A illustrates the spring element 704 in a compressive state and FIG. 7B shows the spring element in a non-compressive state.

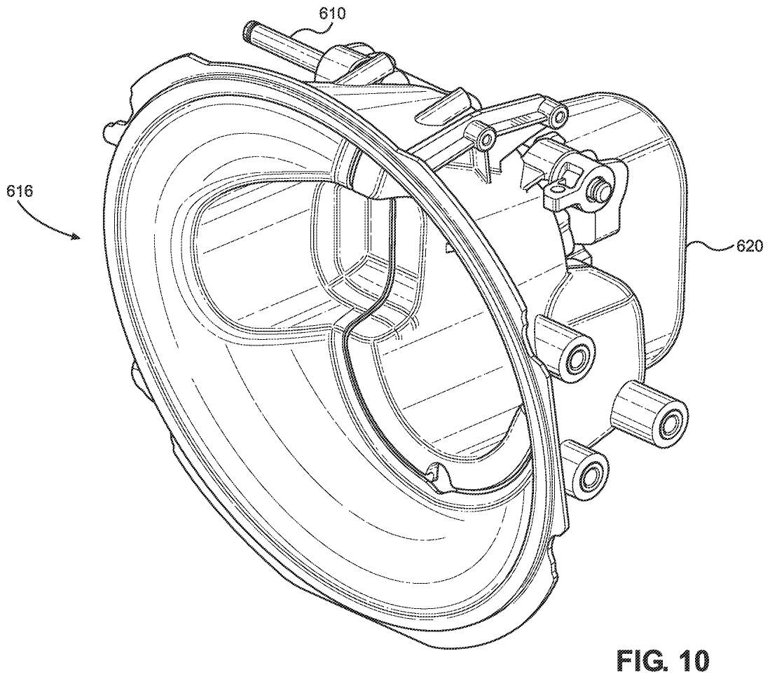

FIG. 10 illustrates a front perspective view of the chute interface 616 of the pod container opening system 600 configured to interface the pod holder 620 to the pod door (not shown). FIG. 10 further illustrates the pod holder 620 hinged about the pod holder shaft 610 to facilitate upward rotation of the pod holder 620.

### Exemplary Step Diagrams of a Pod Opening Sequence

FIGS. 11A-11D illustrate exemplary step diagrams of the pod extraction system at various stages of a pod opening sequence. A pod opening sequence is initiated whenever a user loads a pod into the beverage apparatus 100 to initiate a brewing process. The step diagrams illustrate, by way of non-limiting example only, how a pod 202 is rotated from the closed state to the open state to release the beverage elements 212 into a brewing chamber (not shown). The various stages of the pod opening sequence are arbitrarily selected snap shots in time as the pod 202 is rotated from the closed state to the open state.

FIG. 11A illustrates an initial closed state of a pod 202, prior to rotation. At this stage, pod holder 610, beverage elements 212 are wholly contained within the pod 202. Pod door 902 is shown in a closed position, abutting pod holder 620. The pod lid clamp assembly 700, shown directly below the electromechanical opening module 600 acts to compress the exposed portion (not shown) of pod lid 206 against pod door 902. Upon insertion into the pod holder 620 and prior to rotation, the pod 202 is angled at an approximately 10 degree downward angle from horizontal.

FIG. 11B illustrates a partial open state of pod 202. By way of example only, The pod 202 and pod holder 610 have transitioned from the closed state to the partially open state at approximately a 15 degree upward angle from horizontal. At this intermediate stage of rotation, the pod lid clamp assembly 700 maintains the compressive force that was initially applied to the pod lid 206 in the closed state at the pod insertion stage. The compressive force applied against the exposed portion 208 (FIG. 2) of the pod lid serves as an anchor point to allow the pod lid 206 to be stripped from the pod container 204 as the pod holder 620 continues to be rotated upwards. Some beverage elements 212 may begin to be released from the pod 202 at this stage of inclination.

FIG. 11C illustrates a further partial open state of pod 202 as the pod transitions from the closed state to the open state. At this stage, the pod 202 and pod holder 610 have transitioned to a partially open state, having an inclination angle of approximately 30 degrees from horizontal. At this stage of rotation, the pod lid 206 becomes increasingly separated from the pod container 204 as the inserted pod 202 continues its counterclockwise rotation towards the fully open state while the exposed portion 208 (FIG. 2) of the pod lid 206 remains stationary via the continually maintained compressive force applied by the pod lid clamp assembly 700. Additional beverage elements 212 continue to be released from the pod 202 at this stage of inclination.

FIG. 11D illustrates a further partial open state of pod 202 as the pod 202 transitions from the closed state to the open state. At this stage of rotation, the pod 202 and pod holder 610 have transitioned to a partially open state, having an inclination angle of approximately 45 degrees from horizontal. At this stage of rotation, the pod lid 206 becomes increasingly separated from the pod container 204 as the pod 202 continues its counterclockwise rotation towards the fully open state while the exposed portion 208 (FIG. 2) of the pod lid 206 remains stationary via the continually maintained compressive force applied by the pod lid clamp assembly 700. Additional beverage elements 212 continue to be released from the pod 202 at this stage of inclination. It should be understood that the rotation continues from this point and ends at approximately 60 degrees. However, in some embodiments, the counterclockwise rotation terminates anywhere in the range of substantially 60-70 degrees from horizontal.

### Extraction Process

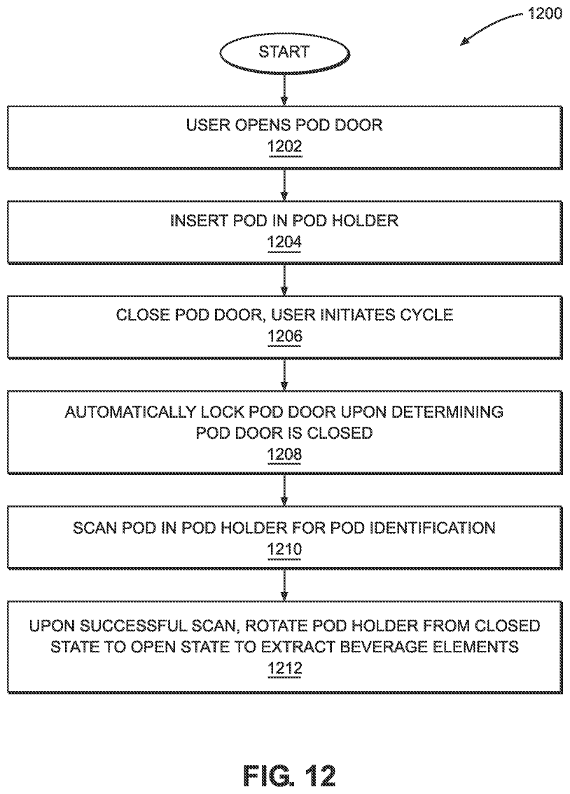

FIG. 12 is a flowchart of an example method 1200 of the present disclosure of extracting whole beverage ingredients from a pod 202 for use in a beverage brewing apparatus, according to an embodiment. The method 1200 may be performed, for example, in the beverage brewing apparatus of FIG. 1.

It should be understood that the following operations are described in a specific order in one example embodiment. However, any operation of FIG. 12 can occur in any order, can include additional operations, or fewer operations than shown and described.

The extraction method 1200 includes a beginning operation 1202, where a user opens a pod door 902.

At operation 1204, the user inserts the pod 202 into a pod holder 620 of the electromechanical opening module 600 via the chute interface 616 configured to interface the pod holder 620 to the pod door 902.

At operation 1206, the pod door 902 is closed by the user. The user then initiates a brewing process.

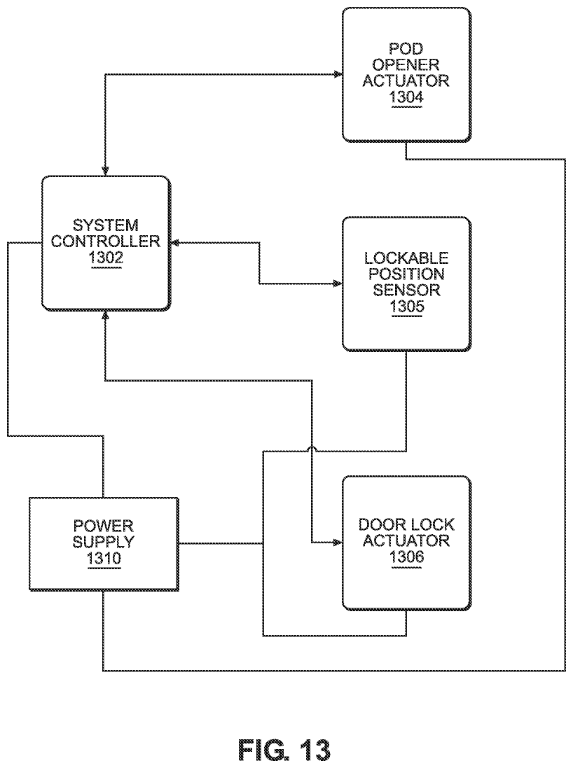

At operation 1208, a main controller 1302 automatically locks the pod door 900 upon determining that the pod door 902 has been closed by the user. In an embodiment, closing of the pod door may be determined by a reed sensor 612 located on a back face of the chute interface 616. The reed sensor 612 is configured to detect a magnet arranged in the pod door 902 as the chute interface 616 moves closer to the pod door 902. Upon detecting the magnet on the pod door 902, a signal is transmitted to a system controller (FIG. 13) informing the system controller that the pod door 902 has been closed.

At operation 1210, the main controller 1302 performs a scan on a machine-readable code embossed on each pod 202 to obtain information about the pod's specific beverage elements 212 or a brewing process pertaining to the pod's beverage elements 212. The readable code may comprise any type of machine-readable code, such as a barcode, a QR code, text, datamatrix codes, a picture, a symbol, or any other scannable data element.

At operation 1212, upon successfully performing the scan, the pod container opening system 600, 700 begins to peel away a portion of the pod lid 206 as the pod 202 is rotated upwards in the pod holder 260 from the closed state to the open state to extract the pod's beverage elements 212 as part of an overall brewing cycle.

### System Controller

FIG. 13 is a diagram of a system controller 1302 for controlling a number of operations associated with the beverage brewing apparatus 100 of FIG. 1. In an example embodiment, the system controller 1302 can be implemented as a processor executing computer instructions for controlling the various operations of the beverage brewing apparatus. Generally, system controller 1302 is connected to power supply 1310 and is programmed to detect the presence of input signals received from various sensors/actuators of the brewing apparatus and output various control signals in response to the received sensor/actuator signals. In some embodiments, the sensors can be any type of sensor known to those knowledgeable in the art, including, for example, mechanical sensors, optical sensors, electrical sensors, electromagnetic sensors and combinations thereof.

In operation, a user opens pod door 902 (FIG. 9) to insert pod 202 and closes pod door 902 to initiate a brewing cycle, as described above, a lockable position sensor 1305 arranged in door lock assembly 618 (FIG. 6A) detects whether pod door 902 is in a lockable position. Pod door 902 must be in a lockable position to enable locking the pod door 902 via an electronic pod lock. Upon determining that pod door 902 is in a lockable position, lockable position sensor 1305 transmits a lockable position confirmation signal back to system controller 1302. Upon receiving the confirmation signal from lockable position sensor 1305 at system controller 1302, system controller 1302 then sends an actuation signal to door lock actuator 1306 to actuate the locking of pod door 902 in the lockable position via an electronic pod lock. In the case where pod door 902 is successfully locked via the actuation signal, door lock actuator 1306 sends a confirmation signal to system controller 1302 confirming a successful door lock operation. Otherwise, if the actuation signal fails to lock pod door 902, system controller 1302 will send at least one additional actuation signal to lock pod door 902. In some embodiments, multiple additional actuation signals (e.g., three or more) may be sent by system controller 1302 in accordance with a fault tolerant protocol. In the case where additional actuation signals fail to lock pod door 902, the user will be notified of the failed attempts, in accordance with the fault tolerant protocol.

Upon determining that pod door 902 has been successfully locked via The receipt of the door lock confirmation signal received from door lock actuator 1306, system controller 1302 then sends a pod opening actuation signal to pod opener actuator 1304 to begin a pod opening sequence, as shown by way of example in FIGS. 11A-11D. In the event the pod opening sequence is successfully initiated, pod opener actuator 1304 sends a positive confirmation signal back to system controller 1302. Otherwise, in the event the pod opening sequence is not successfully initiated, pod opener actuator 1304 sends a negative confirmation signal to system controller 1302.

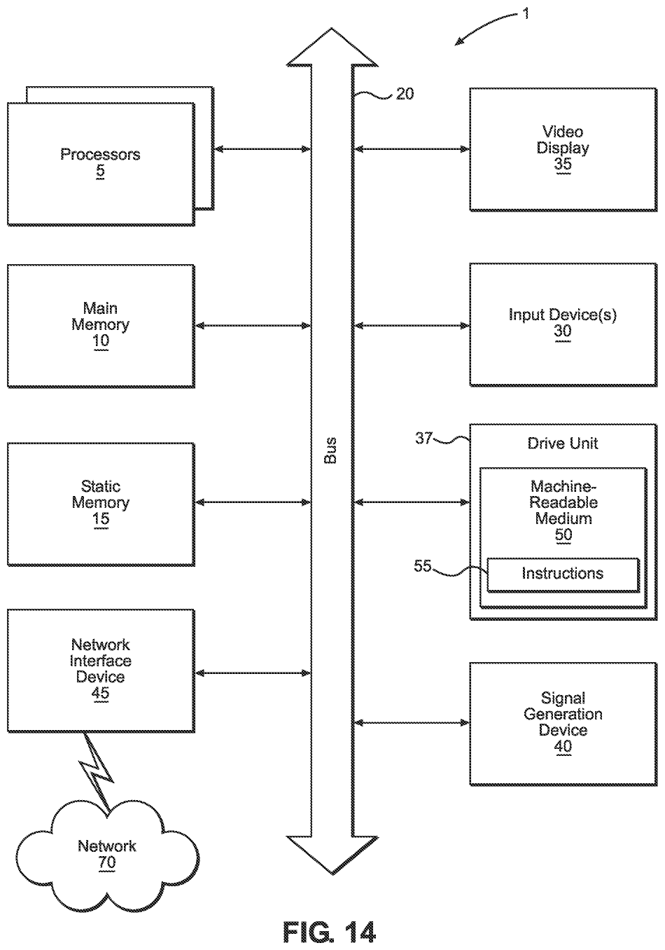

FIG. 14 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be an Internet-of-Things device or system, a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. Instructions 55 may also reside, completely or at least partially, within the main memory 10 and/or within the processor(s) 5 during execution thereof by the computer system 1. The main memory 10 and the processor(s) 5 may also constitute machine-readable media.

Instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 of FIG. 13 are those typically found in computer systems that may be suitable for use with embodiments of the present disclosure and are intended to represent a broad category of such computer components that are well known in the art. Thus, the computer system 1 can be an Internet-of-Things device or system, a personal computer (PC), handheld computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources. The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participates in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications, as well as wireless communications (both short-range and long-range). Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

What is claimed is:

1. A container opening system, comprising:
an electromechanical opening module; and
a pod lid clamp assembly;
a) the electromechanical opening module comprising:
a pod holder arranged to receive pods, the pods being comprised of a pod lid and pod container including whole beverage ingredients;
a pod door configured to enclose the loaded pod in the pod holder during operation;
a chute interface configured to interface the pod holder to the pod safety door;
a pod holder shaft configured to initiate a rotation of the pod holder containing the loaded pod from a closed state to an open state to release whole beverage ingredients contained within the pod; and
b) the pod lid clamp assembly comprising:
a spring mechanism coupled to a knurled exterior surface, the pod lid clamp assembly configured to retain an exposed portion of the pod lid in a fixed position abutting the pod door while the pod opener arm assembly rotates the pod holder including the loaded pod from the closed state to the open state to allow the pod lid to be become substantially separated from the pod container to release the whole beverage ingredients.

2. The container opening system of claim 1, wherein the spring mechanism of the pod lid clamp assembly is configured to apply a mechanical compressive force against the exposed portion of the pod lid to retain the bottom portion in the fixed position abutting the pod door acting as a counterforce to the applied mechanical compressive force.

3. The container opening system of claim 1, wherein in the closed state, prior to rotation, the beverage ingredients are contained within the pod and wherein in the open state the whole beverage ingredients are dispensed from the pod.

4. The container opening system of claim 1, wherein the pod holder is rotatably mounted at a point on the chute.

5. The container opening system of claim 1, wherein the pod opener assembly transitions from a pre-actuated state to an actuated state upon receiving an actuation signal from an actuator responding to received instructions from a memory coupled to a controller to rotate the pod from the closed state to the open state.

6. The container opening system of claim 5, wherein the pod extraction system further comprises an extension spring coupled to the opener arm assembly for returning the opener arm to the pre-actuated state.

7. The container opening system of claim 1, wherein the pod clamp assembly is positioned directly beneath the electromechanical opening module.

8. The container opening system of claim 1, wherein a pod holder is rotated on a pod holder shaft that is retained on the chute by two retaining rings.

9. The container opening system of claim 1, wherein a door lock assembly is mounted on the pod chute configured to secure the pod door to the chute in a locked position during operation.

10. The container opening system of claim 1, wherein the chute further comprises a sensor configured to indicate when the pod holder has returned to a position corresponding to the closed state.

11. The container opening system of claim 1, wherein a notch on the pod base exposes the exposed portion of the pod lid, wherein the exposed portion is retained by the spring mechanism of the pod lid clamp assembly.

12. The container opening system of claim 1, wherein the chute further comprises a mounting plate for mounting elements of the pod opener mechanism including an opener arm, a first opener idler gear, a second opener idler gear, a pinned gear and a pod holder shaft.

13. The container opening system of claim 12, wherein a motive force applied to the opener arm is indirectly transferred to a rotating pod holder shaft via a series of meshed gears including a rotational gear of the opener arm being operably meshed with the first opener idler gear, the first opener idler gear in turn being operably meshed with the second opener idler gear, and the second opener idler gear in turn being operably meshed with the opener pinned gear coupled to the pod holder shaft.

14. The container opening system of claim 1, wherein the pod extraction system further comprises a sensor configured to detect the presence of a magnet in the pod door to automatically determine that the pod door is closed.

15. A method for extracting whole beverage ingredients from a pod in a brewing apparatus, the method comprising:
a) opening a pod door of the beverage brewing apparatus;
b) inserting the pod in a pod holder;
c) closing the pod door to allow user to initiate brewing cycle;
d) automatically locking the pod door upon determining that the pod door is closed;
e) scanning the pod in the pod holder for a pod identification; and
f) upon successfully scanning the pod for the pod identification, initiating the rotation of the pod holder from a closed state to an open state to extract beverage ingredients from the pod.

16. The method of claim 15, wherein the step of initiating the rotation of the pod holder from the closed state to the open state to extract the beverage ingredients further comprises retaining an exposed portion of the pod lid in a fixed position by a pod lid clamp assembly using the pod door as a backstopping contact surface.

17. The method of claim 16, wherein the retention of the exposed portion of the pod lid is achieved by an externally applied mechanical compressive force.

18. The method of claim 16, wherein the contact surface of the pod safety door applies an equal and opposite force to the applied mechanical compressive force.

19. The method of claim 15, wherein the step of automatically locking the pod safety door upon determining that the pod door is closed further comprises detecting the presence of a magnet in the pod door by a sensor to determine that the pod door is closed.

20. A beverage brewing apparatus comprising the container opening system of claim 1.
